(19) United States
(12) Patent Application Publication
(10) Pub. No.: US 2003/0162573 A1
(43) Pub. Date: Aug. 28, 2003

(54) Down-link interference cancellation for high-data-rate channels in advanced digital wireless networks

(76) Inventors: Jyhchau Horng, Warren, NJ (US); Giovanni Vannucci, Red Bank, NJ (US); Jinyun Zhang, New Providence, NJ (US)

Correspondence Address: Patent Department, Mitsubishi Electric,, Research Laboratories, Inc., 201 Broadway, Cambridge, MA, 02139, US

(21) Appl. No.: 10/289,712

(22) Filed: Nov. 7, 2002

Related U.S. Application Data
(60) Provisional application No. 60/358,076, filed on Feb. 19, 2002.

(51) Int. Cl. H04B 17/00; H04B 1/10; H04M 1/00; H04B 1/38

(52) U.S. Cl. 455/570; 455/67.3; 455/296

(57) ABSTRACT

A method cancels interference in a radio signal received in a receiver of a wireless communications network, such as a cellular telephone network. The interfering signals are serially detected, demodulated and decoded. Each of the decoded signals is then regenerated into its analog form and subtracted from the radio signal until a desired signal is recovered.

### CROSS-REFERENCE TO RELATED APPLICATIONS

A claim of priority is made to U.S. Provisional Patent Application Serial No. 60/358,076, filed Feb. 19, 2001, entitled DOWNLINK INTERFERENCE CANCELLATION FOR HIGH-DATA-RATE CHANNELS IN ADVANCED DIGITAL WIRELESS NETWORKS.

### FIELD OF THE INVENTION

Then present invention relates generally to wireless communications networks, and more particularly to interference cancellation in wireless networks.

### BACKGROUND OF THE INVENTION

FIG. 1 shows a typical 3^{rd} generation (3G) wireless network 100, such as UMTS, CDMA-1x, or FOMA network, that uses the invention. The network includes base stations 101-103, low bit rate user devices 111, and high bit rate user devices 112. The low bit rate devices 111 are primarily voice terminals (cellular telephones), pagers, and portable terminals such as personal digital assistants. Low bit rate devices are characterized by limited power, performance, I/O capabilities, and small size. For the high bit rate devices 112, such as personal computers and larger computer systems, power consumption and size are less of a concern, while performance is paramount.

To accommodate those two different categories of devices, 3G wireless networks provide low bit rate channels 121 and high bit rate channels 122. Low bit rate channels, such as voice and packet data channels, provide a guaranteed capacity, which is always a small fraction of total available capacity, at a guaranteed low latency. High bit rate channels, such as a high-bit rate packet-data access (HSDPA) channel in UMTS, provide a variable capacity that can be very high, but latency is unpredictable, and sometimes quite high. In part, this is due to the requirement of providing guaranteed latency to voice channels on the low bit rate channels 121. Note, the channels can be multiple virtual channels in a single physical channel.

Only services where this greater latency and variable capacity are acceptable can take advantage of high bit rate channels. Generally, these channels are intended for applications such as web browsing, file transfers and e-mail, which require greater throughputs than voice, but are, at the same time, tolerant to variable capacity and higher latency. In contrast, latency in voice communications is unacceptable, although the quality of the signal is less important.

In many areas, there is a high density of base stations and user devices. As a result the various signals interfere with each other. As shown in FIG. 1, each device receives simultaneously a superposition of all the transmitted signals if the power level is high enough. For any given device, the signals from the nearest base station will, generally, be strongest.

Interference cancellation (IC) can be used to improve the performance of wireless receivers. Specifically, IC reduces the required signal strength for a given throughput on the wireless channel. In CDMA-based systems, a reduction in the transmitted power level results directly in an increase of total system capacity. Therefore, IC has two possible benefits. It can achieve the same throughput using less of the channel's total capacity, and it can achieve greater throughput without increasing the signal strength.

The wireless channels 121-122 generally include an “up-link” and a “down-link.” The up-link is between a transmitter and a base station, and the down-link is between the base station and a receiver. Interference cancellation as described herein is applicable to both the up- and down-links of low and high bit rate wireless channels, although high bit rate down-links will benefit by a greater amount.

A largest fraction of the available capacity in a wireless system is usually allocated to high bit rate channels, and conversely, voice channels are allocated a smaller fraction. For example, the HSDPA channel in UMTS can consume as much as 80% of total available capacity. As already noted, signal strength and capacity are directly related in CDMA-based systems. Therefore, IC is easier for high bit rate channels than low bit rate voice channels.

In order to perform total IC for a high bit rate channel, the receiver has to detect all the other signals on the channel, including low bit rate voice signals. Similarly, for low bit rate channels, a voice terminal also has to detect all other voice signals, as well as any high bit rate signals to cancel a significant amount of interference in the channel. This substantially increases the complexity of voice terminals.

U.S. Pat. No. 6,404,760 issued Holtzman et al. on Jun. 11 2002, “CDMA multiple access interference cancellation using signal estimation,” describes a method for reducing interference in a CDMA system. An estimate of a strongest interfering signal is formed from analysis of the pilot signal associated with the strongest signal. The estimate is then used to generate a replica of the strongest signal which can be subtracted from a delayed version of the received channel.

The problem with that approach is that the pilot signal's power is relatively high compared with the power for other signals. Therefore, pilot signals are strong interferences. However, Holtzman does not provide any way for canceling interfering pilot signals.

In a wireless systems where interference cancellation is not performed on low bit rate channels, the base-station has to transmit at a higher power to insure that voice terminals reliably receive and detect the signals in spite of the interference caused by all the other low and high bit rate signals that are present in the channel. In CDMA-based systems, where all signals share the same channel, this is generally achieved with closed-loop power control. Each voice terminal sends a feedback signal to the base station. This feedback signal is used to adjust the signal strength on the down-link to insure that it is adequate at the receiver.

### SUMMARY OF THE INVENTION

A method cancels interference in a radio signal received in a receiver of a wireless communications network, such as a cellular telephone network.

The interfering signals are serially detected, demodulated and decoded. Each of the decoded signals is then regenerated into its analog form and subtracted from the radio signal until a desired signal is recovered.

### BRIEF DESCRIPTION OF THE DRAWINGS

FIG. 1 is a diagram of “third generation” wireless cellular network that uses use the invention;

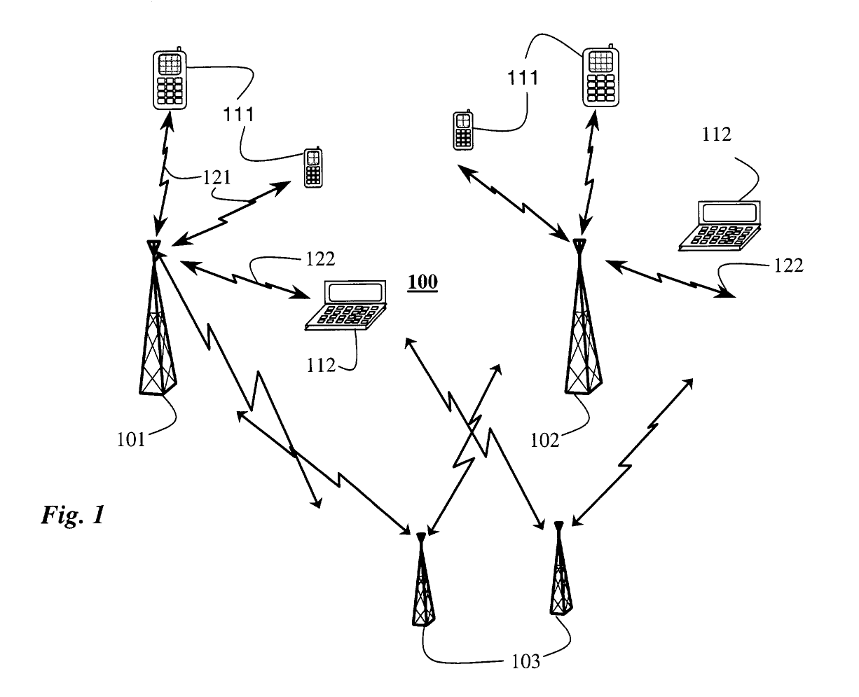

FIG. 2 is a block diagram of overall down-link signal received by a high-bit rate-data user device; and

FIG. 3 is a block diagram of a circuit for interference cancellation according to the invention; and

FIG. 4 is a flow diagram of an interference cancellation method according to the invention.

### DETAILED DESCRIPTION OF THE PREFERRED EMBODIMENT

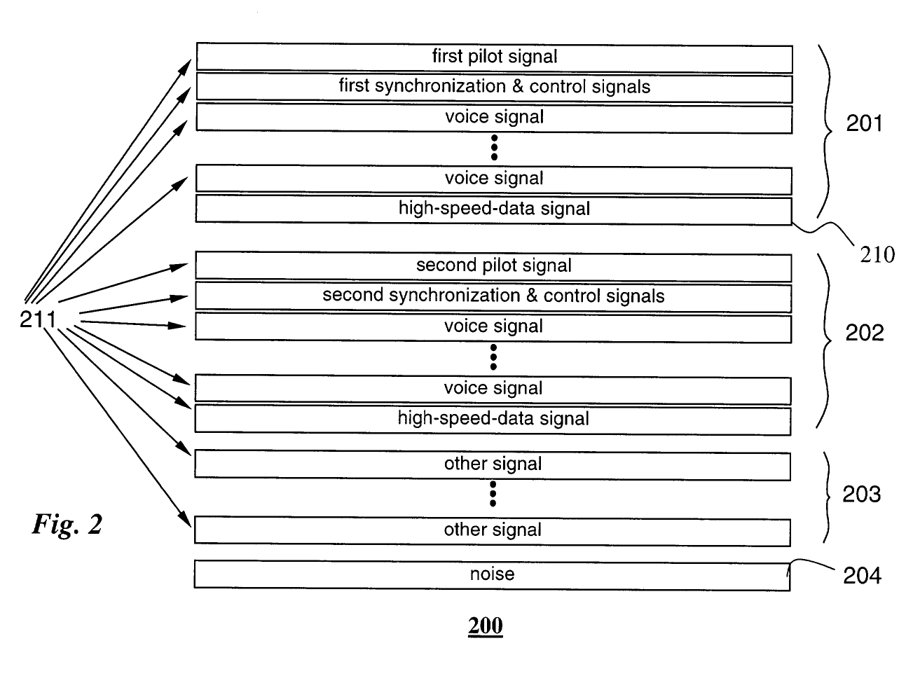

FIG. 2 shows a down-link radio signal 200 received by a high bit rate user device. The signal 200 includes groups of down-link signals 201-203, and noise 204. Some signals, such as pilot, synchronization, and control signals, are transmitted at a relatively high power levels. Other signals, such as low bit rate voice signals and high bit rate data signals, are transmitted at a signal level determined on the basis of a feedback signal.

For the purpose of the invention, all signals 211 and noise 204, except for the desired signal 210, are considered interfering and ought to be cancelled. Of particular concern or interfering signals with a moderate to high power level, such as the pilot, control, and sync signals. Interfering signals with a substantially low power level, e.g., signals from far away base stations, other user devices, and noise, can be ignored for most practical applications. Thus, for example, only interfering signals having a power level above a predetermined threshold need be considered. The threshold can be relative to the power level of the desired signal 210.

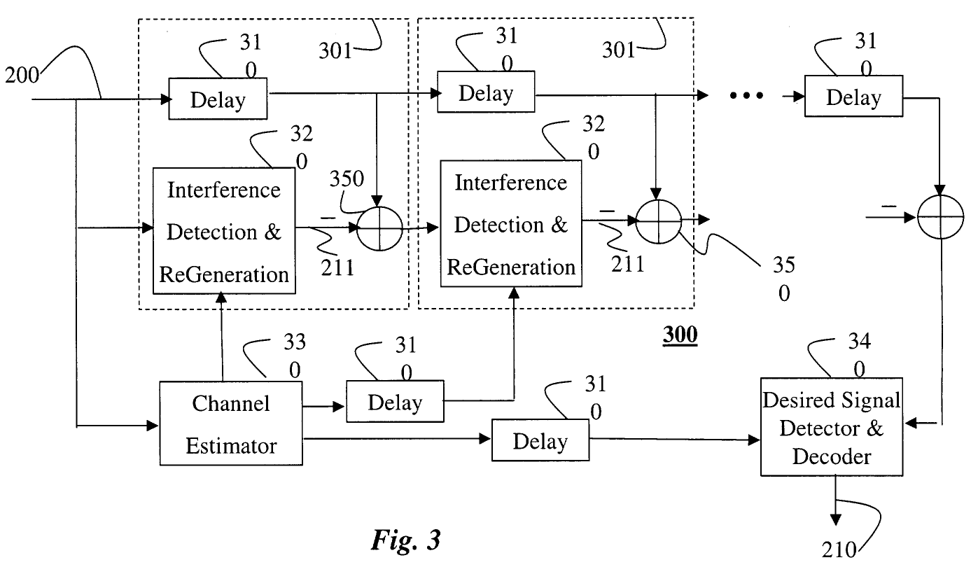

FIG. 3 shows a circuit 300 for interference cancellation according to the invention. The circuit includes multiple delays 310, interference detection and regeneration modules 320, and adders 350 arranged in, for example, four stages 301. In addition, the circuit 300 includes a channel estimator 330 and a desired signal detector and decoder 340.

The circuit 300 takes as input all received radio signals 200. The input radio signals 200 includes the interfering signals 211 and the desired signal 210. Each stage 301 cancels one of the interfering signals 211 by subtracting a regenerated version of the interfering signal from the input signal, until just the desired signal 210 remains.

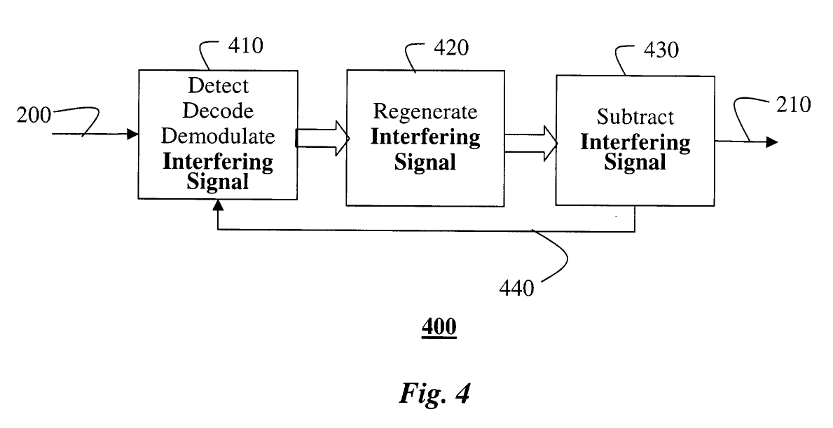

FIG. 4 shows the steps of a method 400 performed by the circuit 300. Step 410 detects, decodes, and demodulates one of the interfering signals 211 from the input signals 200. This can be done knowing the spreading codes, modulation formats, frequencies, scrambling codes and user masks, and channel impulse response. Well known “rake” receiver structure, e.g., the channel estimator 330 and the like, commonly used in a CDMA radio receiver, provides such estimates as a normal by-product of its operation. If these parameters are unknown, a best guess estimate can be used to allow for the regeneration of an approximation to the interfering signal 211.

The analog of the interfering signal is then regenerated in step 420.

The regenerated interfering signal 211 is than subtracted 430 from the input signal 200, all with appropriate delays to time-align the various versions of the signals. This operation effectively removes the interference caused the desired signal 210 to be detected in step 410.

This process is repeated serially 440 for each of the stages 301 until only the desired signal 210 remains which can be detected and decoded by module 340 of FIG. 3.

As noted before, in a CDMA-based system, the power level of each transmitted signal is adjusted on the basis of feedback information from the intended receiver. Thus, the level of each transmitted signal is sufficient to be successfully detected by the intended receiver, but not necessarily sufficient for successful detection by other receivers.

However, in the down-link, most receivers experience a very similar interference environment, and the transmitted power level needed to satisfy the intended receiver will be close to the transmitted power level required to make the signal detectable by other receivers as well.

Because of the iterative nature of the method 400, at every iteration more interfering signals become detectable, and the performance of the circuit 300 improves with each stage 301 canceling out the most “powerful” interfering signals if, for example, three to ten stages are used. A reasonable result can be obtained with three to five stages.

There may be a case where few or none of the interfering signals 211 are received with a power level strong enough for successful detection. This may occur, for example, when a high bit rate data receiver far from the base station and near the cell boundary, and interference from other cells is particularly strong.

In other cases, the power level of the signal received by the high bit rate receiver is only slightly less than what the receiver needs for successful detection of the interfering signals. It is known that most receivers experience a very similar interference environment, so that this occurrence is not uncommon. When this happens, a small increase in the transmitted signal level of interfering signals can actually improve the interference cancellation according to the invention.

Accordingly, the invention can provide a feedback-based power-control technique that allows for the adjustment of power levels of other signals. For example, if the power level specified by a high bit rate receiver is higher than the power level specified by the intended recipient, then the base station can, optionally, adopt a higher of the two levels. This meets the requirements of the intended receiver with additional margin, and enables the high bit rate receiver to successfully detect, demodulate, decode and cancel a “high power” voice signal.

As described above, it is assumed that the receiver is able to detect, demodulate and decode interfering signals intended for other recipients. For this to be true, the receiver needs to know various parameters of the modulation and encoding schemes, such as spreading code, error correction code, coding rate, etc. These parameters are conveyed to the intended receiver when a channel is set up, and refreshed as needed if they are modified at a later time.

However, all modern digital wireless networks employ encryption to protect the privacy of user data. It is important to note that, for IC to be successful, the high bit rate receiver does not need to decrypt the data in the interfering signals. Knowing the channel parameters is sufficient. The high bit rate receivers only needs to detect the bits for the purpose of regenerating the interfering waveform, while the receiver does not need to decipher the data contained therein.

Thus, it is advantageous to the invention to transmit encrypted signals for privacy. However, channel parameters required for detection, demodulation and decoding of the encrypted data are transmitted without encryption, or with an encryption method that can be deciphered by an IC-capable receiver according to the invention.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for canceling interference in a radio signal in a wireless communications network, comprising:
detecting, demodulating and decoding all of a plurality of interfering signals contained in the radio signal;
regenerating all of the interfering signals from the detected, demodulated and decoded signals; and
subtracting all of the regenerated interfering signals from the radio signal to recover a desired signal.

2. The method of claim 1 wherein the detecting, regenerating, and subtracting are performed serially for each of the interfering signals.

3. The method of claim 1 wherein the interfering signals include groups of down-link radio signals.

4. The method of claim 3 wherein each group of down-link radio signals includes a pilot signal, a synchronization and control signal, and a voice signal.

5. The method of claim 3 wherein the groups of down-link radio signals include high bit rate and low bit rate signals.

6. The method of claim 1 further comprising:
estimating a channel impulse response for each interfering signal.

7. The method of claim 1 wherein the desired signal is received from a first base station, and the interfering signals are received from a second base station.

8. The method of claim 1 further comprising:
requesting a transmitter of a particular interfering signal to increase a power level of the particular interfering signal.

9. The method of claim 8 wherein the request is made via a feedback signal from a receiver of the particular interfering signal.

10. An apparatus for canceling interference in a radio signal received in a receiver of a wireless communications network, comprising:
a plurality of stages, each stage further comprising:
means for detecting, demodulating and decoding all of a plurality of interfering signals contained in the radio signal;
means for regenerating all of the interfering signals from the detected, demodulated and decoded signals; and
means for subtracting all of the regenerated interfering signals from the radio signal to recover a desired signal.

11. The apparatus of claim 10 further comprising:
delay lines coupling the plurality of stages.

12. The apparatus of claim 10 further comprising:
a channel estimator determining channel impulse responses of the interfering signals.
